(19) United States
(12) Patent Application Publication
(10) Pub. No.: US 2018/0009462 A1
(43) Pub. Date: Jan. 11, 2018

(54) DECORATIVE MEMBER FOR STEERING WHEEL

(71) Applicant: KABUSHIKI KAISHA TOKAI RIKA DENKI SEISAKUSHO, Aichi (JP)

(72) Inventors: Ichiro YAMAMOTO, Aichi (JP); Yoshiaki MAEKUBO, Aichi (JP)

(21) Appl. No.: 15/630,357

(22) Filed: Jun. 22, 2017

(30) Foreign Application Priority Data
Jul. 8, 2016 (JP) 2016-135785
Jul. 15, 2016 (JP) 2016-139924

(51) Int. Cl. B62D 1/06; B44F 9/02; B29C 45/14; B29C 45/16; H05B 3/34; B29L 31/00; B29K 75/00; B29L 31/30

(52) U.S. Cl. CPC B62D 1/06; B29C 45/1671; B44F 9/02; H05B 3/342; H05B 3/347; B29C 45/1418; B29K 2075/00; B29K 2995/0021; B29L 2031/3047; H05B 2203/015; H05B 2203/016; B29L 2031/722

(57) ABSTRACT

A decorative member for a steering wheel which is used for being attached to a resin member formed around a ring core metal of a steering wheel. The decorative member includes a base layer attached to the resin member, a design part arranged on the base layer, and a heater arranged between the design part and the base layer. The base layer may include an extraction part at an intermediate position in a longitudinal direction thereof such that a lead wire connected with the heater is led out of the extraction part.

The present application is based on Japanese patent application Nos. 2016-139924 filed on Jul. 15, 2016, and 2016-135785 filed on Jul. 8, 2016, the entire contents of which are incorporated herein by reference.

### BACKGROUND OF THE INVENTION

### 1. Field of the Invention

This invention relates to a decorative member for a steering wheel to improve the surface aesthetic appearance of the steering wheel. Especially, this invention relates to a decorative member for a steering wheel mounted on a ring portion of the steering wheel.

### 2. Description of the Related Art

A steering wheel is known that uses a decorative member as an example of the steering wheel that improves an appearance of the steering wheel (see e.g. JP-A-2010-126016, and JP-A-2010-036840).

The steering wheel disclosed by JP-A-2010-126016 is provided with a circular rim core metal, and a rim (filler) made from soft elastic material such as foamed polyurethane, which covers the rim core metal. A surface of the rim has a section that one pair of decorative members formed in approximately semicircular shaped cross section covers, and another section that leather covers.

The decorative member is formed of a hard member decorated with a wood effect. A sheet heating element is bonded on an inner surface of the decorative member. The sheet heating element is formed by sewing a heater wire into an insulating sheet base layer made of a non-woven fabric.

The steering wheel disclosed by JP-A-2010-036840 that the applicant has previously proposed is provided with a circular rim core metal covered by a resin molded body made of hard urethane foam. The surface of the rim core metal has a section that one pair of wood members made from a thin board having approximately semicircular shaped cross section covers, and a section that outer leather covers.

The outer leather is provided with a bending end that is bent at substantially right angle to rim core metal side. A gap for inserting the bending end of the outer leather thereinto is arranged between opposite surfaces of the wood member and of the outer leather.

A heater is adhered to an inner surface of the wood member. Both ends of the heater in extending direction have electrical terminals with different polarity. The electrical terminal of the heater is connected to an end of wire that passes through the gap arranged between the opposite surfaces of the wood member and the outer leather. The wire is inserted into an insulating wiring cover fixed on core metal in the rim core metal. The wire is electrically connected to a controller with extending for vehicle side.

### SUMMARY OF THE INVENTION

In the steering wheel disclosed by JP-A-2010-126016, most of heat may transfer from the sheet heating element to the rim core metal side with a high heat conductivity if the sheet heating element is arranged close to the rim core metal side. This problem will demand how to solve the heat loss from the sheet heating element.

In the steering wheel disclosed by JP-A-2010-036840, when inserting the bending end of the outer leather (hereinafter referred to as “leather”) into the gap between the opposite surfaces of the wood member and the leather, the leather is likely to wrinkle because of being obstructed by the wire. It is hard to avoid the wrinkling of the leather when inserting the bending end of the leather. This may cause a reduction in product appearance quality.

It is an object of the invention to provide a decorative member for a steering wheel that improves a heat conductivity from the sheet heating element.

It is another object of the invention to provide a decorative member for a steering wheel that is enhanced in product appearance quality.

[1] According to an embodiment of the invention, a decorative member for a steering wheel, which is used for being attached to a resin member formed around a ring core metal of a steering wheel, comprises:

a base layer attached to the resin member;

a design part arranged on the base layer; and

a heater arranged between the design part and the base layer.

[2] The decorative member for a steering wheel according to [1], wherein the heater comprises a heater wire to heat the design part and a reinforcement to reinforce the heater wire.

[3] The decorative member for a steering wheel according to [1] or [2], wherein the base layer comprises a resin material.

[4] The decorative member for a steering wheel according to any one of [1] to [3], wherein the base layer comprises a sliced veneer.

[5] According to another embodiment of the invention, a decorative member for a steering wheel, used for being attached to a resin member formed around a ring core metal of a steering wheel, comprises:

a base layer attached to the resin member;

a design part arranged on the base layer; and

a heater arranged between the design part and the base layer,

wherein the base layer comprises an extraction part at an intermediate position in a longitudinal direction thereof, and

wherein a lead wire connected with the heater is led out of the extraction part.

[6] The decorative member for a steering wheel according to [5], wherein the extraction part comprises an opening formed so as to expose a part of a heater wire of the heater.

[7] The decorative member for a steering wheel according to [5] or [6], wherein the extraction part comprises a wire receiving part to connect a heater wire of the heater with the lead wire.

[8] The decorative member for a steering wheel according to any one of [5] to [7], wherein the design part comprises a sliced veneer.

### Effects of the Invention

According to an embodiment of the invention, a decorative member for a steering wheel can be provided that improves a heat conductivity from the sheet heating element.

According to another embodiment of the invention, a decorative member for a steering wheel can be provided that is enhanced in product appearance quality.

### BRIEF DESCRIPTION OF THE DRAWINGS

Next, the present invention will be explained in conjunction with appended drawings, wherein:

FIG. 1 is a plan view showing a steering wheel comprising a decorative member according to the first embodiment in the present invention;

FIG. 2 is an enlarged cross sectional view showing the decorative member cut along the line II-II in FIG. 1;

FIG. 3 is a perspective view showing a part of the decorative member according to the first embodiment;

FIG. 4 is an enlarged cross sectional view showing a part of the decorative member cut along the line in an extending direction according to the first embodiment;

FIG. 5 is a perspective view showing a part of the decorative member according to the second embodiment;

FIG. 6 is an enlarged cross sectional view showing the decorative member cut along the line in an extending direction according to the second embodiment; and

FIG. 7 is an enlarged cross sectional view corresponding to FIG. 6 showing a part of the decorative member in variation according to the second embodiment.

### DETAILED DESCRIPTION OF THE PREFERRED EMBODIMENTS

### First Embodiment

Next, the first embodiment according to the invention will be described below with reference to the appended drawings.

(Structure of Steering Wheel)

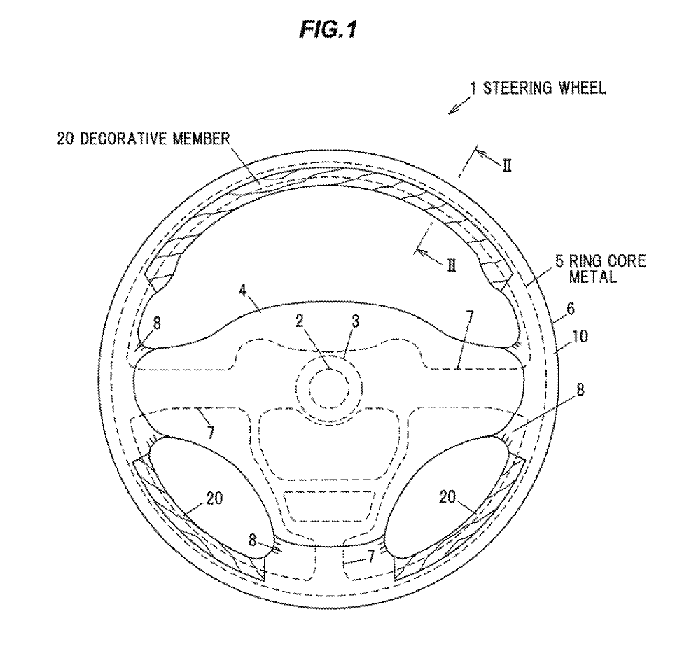

The reference numeral 1 in FIG. 1 showing the whole schematically denotes a steering wheel for vehicle comprising a conventional decorative member 20 according to the present embodiment. Hereinafter, a front surface of the steering wheel 1 may be referred to as “front part”, a rear surface of the steering wheel 1 may be referred to as “back part”, and directions of the steering wheel 1 viewed from the front surface are referred to as “vertical and horizontal directions”.

The steering wheel 1 shown in FIG. 1 is provided with a cylindrical boss 3 fitted and fixed on a tip end of steering shaft 2, a pad 4 mounted on the top of the boss 3, a ring portion 6 covering a ring core metal 5, and a spoke 8 that partly covers three spoke core metals 7 that connect the ring core metal 5 of the ring portion 6 and the boss 3 each other.

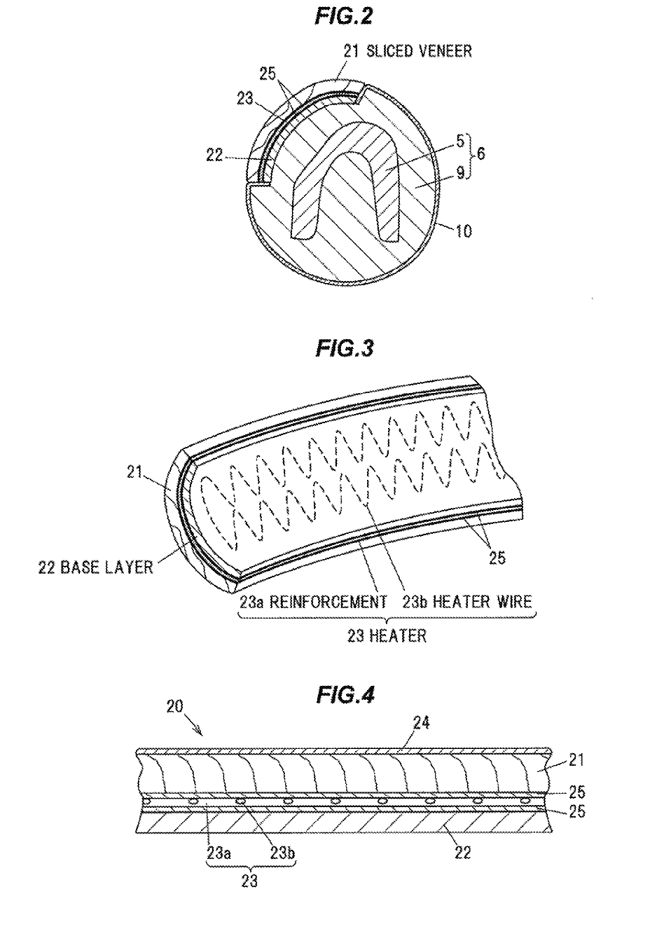

As shown in FIGS. 1 and 2, a cover 9 made from resin member such as polyurethane covers an outer periphery of the ring portion 6 and an outer periphery of the spoke 8. A cuticle 10 made of leather and a decorative member 20 having a design surface that improves appearance design in the steering wheel 1 are mounted on the surface of the cover 9.

(Structure of Decorative Member)

The decorative member 20 shown in FIG. 1 is provided with three members, the decorative member 20 at an upper side of the ring portion 6, which is a holder held by driver, the decorative member 20 at a left obliquely downward side of the ring portion 6, and the decorative member 20 at a right obliquely downward side of the ring portion 6. As shown in FIG. 1, these decorative members 20 are mounted on the inner peripheral side of the ring portion 6 of the steering wheel 1. Meanwhile, the decorative members 20 may be mounted on the outer peripheral side of the ring portion 6.

The decorative member 20 at the upper side of the ring portion 6 will be explained below. Meanwhile, the decorative members 20 at the left and right obliquely downward sides of the ring portion 6 have similar shape and structure in the decorative member 20 at the upper side of the ring portion 6. Therefore, the explanation of the decorative members 20 at the left and right obliquely downward sides of the ring portion 6 is omitted.

As shown in FIGS. 2 to 4, the decorative member 20 comprises a sandwich structure which puts a heater 23 between a sliced veneer 21 that forms a design part and a base layer 22 that fixes the ring portion 6.

The sliced veneer 21 is made from a single board by sharpening natural wood into a predetermined thickness. The sliced veneer 21 is formed so as to be a curved shape. The sliced veneer 21 extends and curves along the extending direction of the ring portion 6. The sliced veneer 21 substantially covers a quadrant part of driver side opposite surface of the ring portion 6. For example, material of the sliced veneer 21 is such as walnut, maple, or bamboo forest.

A clear coating layer 24 can be formed by coating color clear paint and clear paint on the front surface of the sliced veneer 21. A heater 23 is bonded on the rear surface of the sliced veneer 21 by a bonding member 25. For example, hot melting sheet is used as the bonding member 25.

The heater 23 is a sheet heating element. For example, the heater 23 is formed by sewing heater wire 23b into a heat conductive reinforcement 23a made from textile sheet member. For example, non-woven fabric, woven fabric, or braided fabric is used suitably as the reinforcement 23a. Various type heater wires heated by electrically conducting are used as the heater wire 23b. For example, the heater wire 23b that is a wire having core wire made of nickel chrome wire whose surface is covered by insulating film is named

The heater wire 23b is preferable to be arranged in the reinforcement 23a closer to the rear surface of the sliced veneer 21. The heater wire 23b extends in waveform shape, which crosses alternately along the extending direction of the ring portion 6. Not shown terminals having different polarity each other are connected to both ends of the heater wire 23b. The heater wire 23b is electrically connected to a control circuit through lead wires (not shown) connected to each terminal. The heater wire 23b is heated by turning on electricity through the control circuit.

The base layer 22 is bonded on the rear surface side of the heater 23 by the bonding member 25. For example, resin material such as polyamide resin or wood material can be used as the material of the base layer 22. The rear surface of the sliced veneer 21 is a laminate structure that bonds the base layer 22 and the heater 23 by the bonding member 25. This laminate structure has a function as the reinforcement for the thin sliced veneer 21. The base layer 22 is fixed on the ring portion 6 by the fixing method such as snap fitting or bonding.

Variations of the decorative member for steering wheel 20 according to the first embodiment will be explained below.

(Variations)

A molding body that the sliced veneer 21 and the heater 23 are integrated with the base layer 22 can be formed by inserting the sliced veneer 21 and the heater 23 into an injection molding die in advance, and molding resin that performs as the base layer 22 in the molding die.

### Advantageous Effects of the First Embodiment

According to the decorative member for steering wheel 20 in the first embodiment, advantageous effects described below will be provided in addition to the above advantageous effects.

Since the heater wire 23b is formed in the surface of the reinforcement 23a closing to the rear surface of the sliced veneer 21, the heater wire 23b can be arranged nearby the surface of the sliced veneer 21. Therefore, the decorative member for steering wheel 20 can improve the heat conductive efficiency comparing with the conventional structure such that the heater 23 is arranged in the cover 9 of the ring portion 6 such as polyurethane, and can easily conduct the heat from the heater 23 to driver's finger.

The heater 23 can be arranged in space formed between the sliced veneer 21 and the base layer 22 without increasing a number of parts.

Since the heater 23 is arranged in the space formed between the sliced veneer 21 and the base layer 22, bending or disconnecting the heater wire 23b caused by a fold in the reinforcement 23a can be prevented in mounting the decorative member 20 on the cover 9 of the ring portion 6 such as polyurethane. Thus, durability of the heater 23 can increase.

Since the heater wire 23b fails to join the cover 9 of the ring portion 6 such as polyurethane, the decorative member 20 can obtain enough mounting strength.

### Second Embodiment

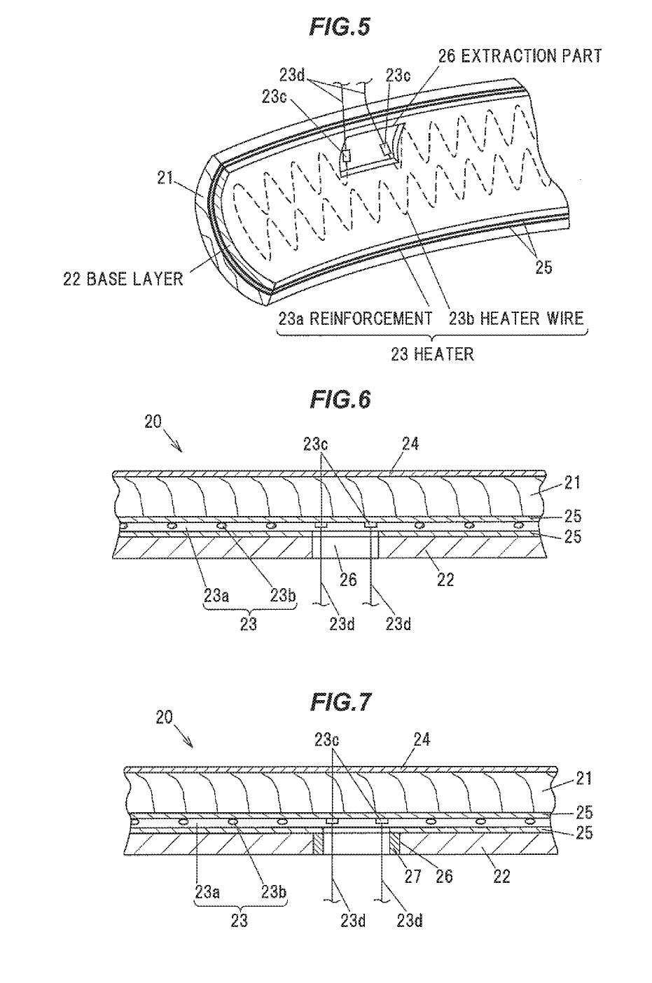

Next, the second embodiment according to the invention will be described below with reference to the appended drawings. The difference from the first embodiment is that the base layer 22 comprises an extraction part 26 so as to lead out the lead wire 23d in the decorative member 20 in the second embodiment. The other structures of the decorative member 20 in the second embodiment are similar to the decorative member 20 in the first embodiment. FIG. 5 is a perspective view showing a part of the decorative member according to the second embodiment. FIG. 6 is an enlarged cross sectional view showing the decorative member cut along the line in the extending direction according to the second embodiment. FIG. 7 is an enlarged cross sectional view corresponding to FIG. 6 showing a part of the decorative member in variation according to the second embodiment.

In the second embodiment, as shown in FIGS. 5 and 6, the base layer 22 is provided with the extraction part 26 so as to lead out the lead wire 23d connected with a terminal 23c of the heater wire 23b. The extraction part 26 is made from an opening formed by piercing an intermediate part of the base layer 22. And the lead wire 23d is inserted into the opening. This structure makes it unnecessary to insert the lead wire 23d into a parting member 11 between the cuticle 10 and the sliced veneer 21. The lead wire 23d fails to obstruct in fitting a bending end of the cuticle 10 made of the leather.

A variation of the decorative member for steering wheel 20 according to the second embodiment will be described below.

(Variation)

As shown in FIG. 7, the extraction part 26 can be provided. The extraction part 26 can comprise a cylindrical extraction tube 27 bonded on the inner peripheral surface of the base layer 22. The cylindrical extraction tube 27 is an extraction hole for the lead wire 23d connected to the terminal 23c of the heater wire 23b. The outer peripheral surface of the extraction hole of the cylindrical extraction tube 27 is bonded on the inner peripheral surface of the base layer 22. The lead wire 23d is inserted into the inner peripheral surface of the base layer 22.

For notably affecting advantageous effects caused by the extraction part 26, it is preferable to suitably choose shape or structure etc. As the other variation of the extraction part 26, the extraction part 26 can be formed as a wire receiving part so as to connect the heater wire 23b with the lead wire 23d. The extraction part 26 can be provided as a connector part so as to fit and fix the inner or outer peripheral surface of the connector that is a bonded part (not shown) and inserted into the inner or outer peripheral surface of the extraction hole of the cylindrical extraction tube 27.

A molding body that the extraction part 26 and the cylindrical extraction tube 27 are integrated with the base layer 22 can be formed by inserting the sliced veneer 21 and the heater 23 into an injection molding die in advance, and two-color molding resin that performs as the base layer 22 and resin that performs as the cylindrical extraction tube 27 in the molding die.

Meanwhile, a molding body that the sliced veneer 21, the heater 23, and the cylindrical extraction tube 27 are integrated with the base layer 22 can be formed by inserting the sliced veneer 21, the heater 23, and the cylindrical extraction tube 27 into an injection molding die in advance, and molding resin that performs as the base layer 22 in the molding die.

### Advantageous Effects of the Second Embodiment

According to the decorative member for steering wheel 20 according to the second embodiment, advantageous effects described below will be provided.

The bending end of the cuticle 10 is certainly fixed since the lead wire 23d is inserted into the extraction part 26 formed in the intermediate part of the base layer 22 except the parting member 11 between the cuticle 10 and the sliced veneer 21. The partition between the cuticle 10 and the sliced veneer 21 can be formed attractively.

The bending end of the particle 10 can fit easily. And operation efficiency can increase.

Bending or disconnecting the heater wire 23b caused by the fold in the cuticle 10 and the reinforcement 23a can be prevented. Thus, durability of the heater 23 can increase.

Although, as a representative configuration example in the decorative member for steering wheel 20 according to the present invention, the decorative member for steering wheel used for vehicle is explained. The present invention is not limited to. Obviously, the decorative member for steering wheel can effectively apply to working vehicles such as construction vehicle and agricultural vehicle.

Also, the claimed invention is not intended to be limited to the embodiments, variations, or illustrated examples. Further, it should be noted that all combinations of the features described in the embodiments, variations, or illustrated examples and the examples are not necessary to solve the problems of the invention.

What is claimed is:

1. A decorative member for a steering wheel, which is used for being attached to a resin member formed around a ring core metal of a steering wheel, comprises:
a base layer attached to the resin member;
a design part arranged on the base layer; and
a heater arranged between the design part and the base layer.

2. The decorative member for a steering wheel according to claim 1, wherein the heater comprises a heater wire to heat the design part and a reinforcement to reinforce the heater wire.

3. The decorative member for a steering wheel according to claim 1, wherein the base layer comprises a resin material.

4. The decorative member for a steering wheel according to claim 1, wherein the base layer comprises a sliced veneer.

5. A decorative member for a steering wheel, used for being attached to a resin member formed around a ring core metal of a steering wheel, comprises:
a base layer attached to the resin member;
a design part arranged on the base layer; and
a heater arranged between the design part and the base layer,
wherein the base layer comprises an extraction part at an intermediate position in a longitudinal direction thereof, and
wherein a lead wire connected with the heater is led out of the extraction part.

6. The decorative member for a steering wheel according to claim 5, wherein the extraction part comprises an opening formed so as to expose a part of a heater wire of the heater.

7. The decorative member for a steering wheel according to claim 5, wherein the extraction part comprises a wire receiving part to connect a heater wire of the heater with the lead wire.

8. The decorative member for a steering wheel according to claim 5, wherein the design part comprises a sliced veneer.
